(19) United States
(12) Patent Application Publication
(10) Pub. No.: US 2006/0105819 A1
(43) Pub. Date: May 18, 2006

(54) Portable electronic device's docking cradle on vechicle

(76) Inventor: Bryant Liao, Taipei (TW)

Correspondence Address: Supa Technology Co., Ltd., P.O. Box No. 6-57, Junghe, Taipei 235, TW

(21) Appl. No.: 10/986,601

(22) Filed: Nov. 12, 2004

(51) Int. Cl. H04B 1/40; H04M 1/00

(52) U.S. Cl. 455/569.2; 455/569.1

(57) ABSTRACT

The present invention relates to a docking cradle on a vehicle including a main body, a cradle with a socket formed on the bottom thereof, a width-adjustable fender formed in the front on each side, a hinge complex formed in the rear to connect with an antenna, and an electronic circuit board formed in the main body, wherein the socket being able to be changed for different applications such as a mobile phone, a PDA, or a GPS and the antenna being able to rotate upward, downward, rightward, or leftward. With the width-adjustable fender and the azimuth-adjustable antenna, portable electronic devices, such as a mobile phone, a PDA, or a GPS, thereby being able to be fitted into the docking cradle and connected with the socket as a hand-free device with the best radio receiving quality.

### BACKGROUND OF THE INVENTION

(a) Field of the Invention

The present invention relates to a docking cradle on a vehicle and more particularly for the docking cradle with an adjustable antenna capable of accommodating various portable electronic devices.

(b) Description of the Prior Art

Portable electronic devices such as the mobile phone, PDA, and hand-held GPS are more and more popular in today's life. It is common that people bring and place them on a docking cradle while in a vehicle. As the conventional docking cradle can only fit a specific type portable electronic device and with no antenna incorporated thereof, defects such as not economic in application and no way to enhance radio receiving quality are obvious.

### SUMMARY OF THE INVENTION

The present invention relates to a docking cradle on a vehicle and more particularly for the docking cradle capable of accommodating and fixing various portable electronic devices, besides having an adjustable antenna to enhance radio receiving performance.

The docking cradle as recited above includes a main body, a cradle with a socket formed on the bottom thereof, a width-adjustable fixing plate assemblies with a fender on each side formed in the front, a hinge complex formed in the rear to connect with an antenna, an electronic circuit board formed in the main body, wherein the socket being able to changed for different applications such as a mobile phone, a PDA, or a GPS and the antenna being able to rotate upward, downward, rightward, or leftward. With the width-adjustable fender and the azimuth-adjustable antenna, portable electronic devices, such as a mobile phone, a PDA, or a GPS thereby being able to be fitted in the docking cradle and connected with the socket to form a hand-free device with the best radio receiving quality.

The fixing plate assemblies of the docking cradle as recited above, wherein a pair of symmetric plates formed, being connected through a spring to a fixing pole and having a fender formed on each side, long holes hooking at positioning rods, and chains gearing with a chain wheel, thereby enabling fenders moving outwards or inwards as chains, interacting by the spring force, moving along the chain wheel.

To enable a further understanding of the said objectives and the technological methods of the invention herein, the brief description of the drawings below is followed by the detailed description of the preferred embodiments.

### BRIEF DESCRIPTION OF THE DRAWING

FIG. 1 shows a perspective view of the present invention from the front.

FIG. 2 shows a perspective view of the present invention from the rear.

FIG. 3 shows an exploded elevational view of the present invention.

FIG. 4 shows an exploded elevational view of the present invention in details.

FIG. 5 shows a perspective view of the present invention when in practical application.

FIG. 6 shows another perspective view of the present invention when in practical application.

### DETAILED DESCRIPTION OF THE PREFERRED EMBODIMENTS

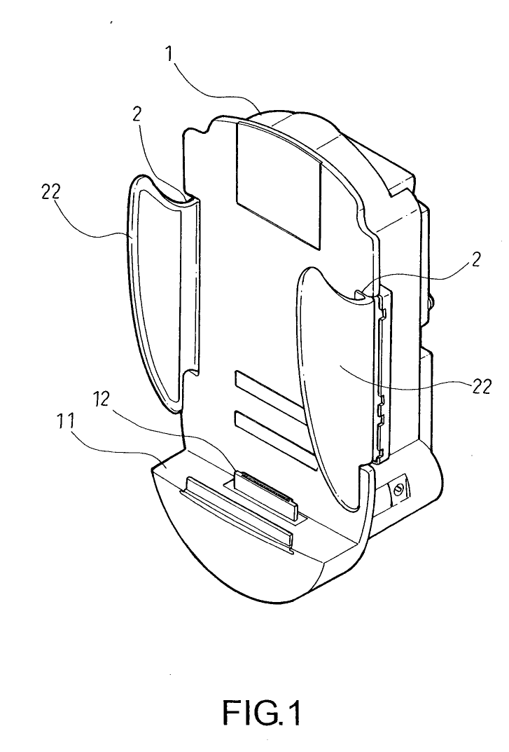

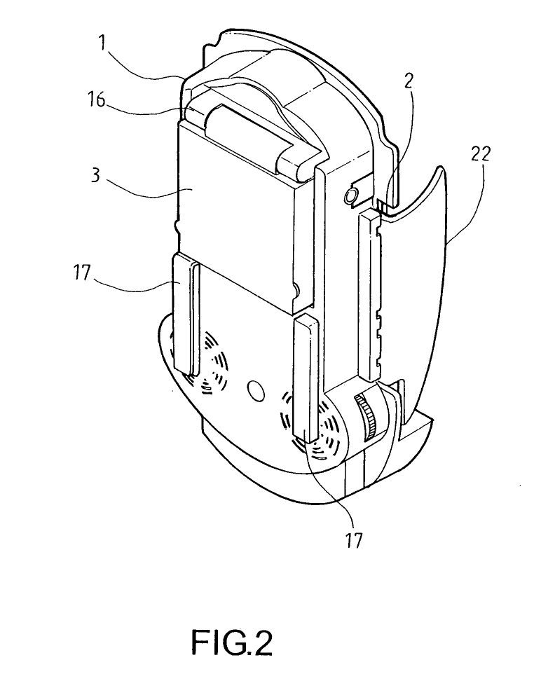

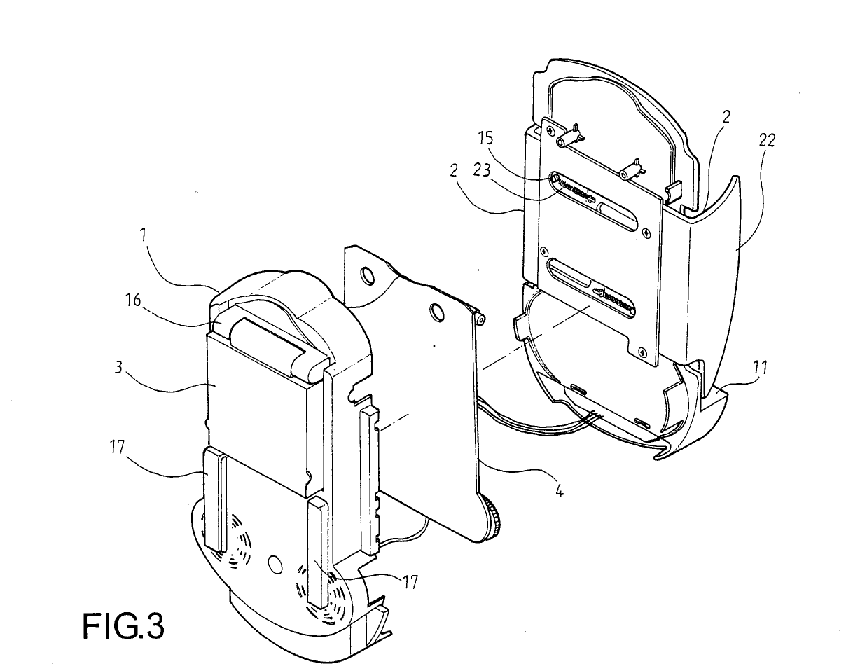

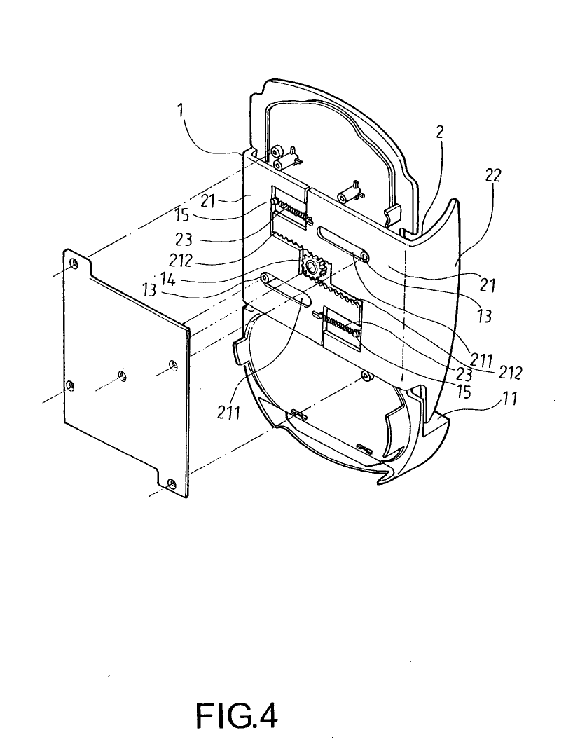

Referring to FIGS. 1 to 4. The present invention relates to a docking cradle on a vehicle including a main body 1, a cradle 11 with a socket 12 formed on the bottom thereof, and a pair of symmetric fixing plate assemblies 2 with a pair of symmetric plates 21 formed in the front, wherein plates 21, being joined through a spring 23 to a fixing pole 15, having a fender 22 formed on each side, two long holes 211 hooking at positioning rods 13, and chains 212 gearing with a chain wheel 14. By moving the chain 212 along the chain wheel 14, interacting with the pulling force by the spring 23, fenders 22 thereby being able to move outwards or inwards.

In the rear of the main body 1, a hinge complex 16 formed to connect with an antenna 3 for the best radio receiving quality when adjusting azimuth, and a dual rail 17 formed on each side to facilitate sliding thereof into a fixture, e.g. on the window, of a vehicle.

Inside the main body 1, an electronic circuit board 4 incorporated to connect to a socket 12, the antenna 13, and other components.

With the width-adjustable fender 22 and the azimuth-adjustable antenna 3, portable electronic devices, such as a mobile phone, a PDA, or a GPS, thereby being able to fit into the docking cradle and connect to the socket 12 as a hand-free device with the best radio receiving quality.

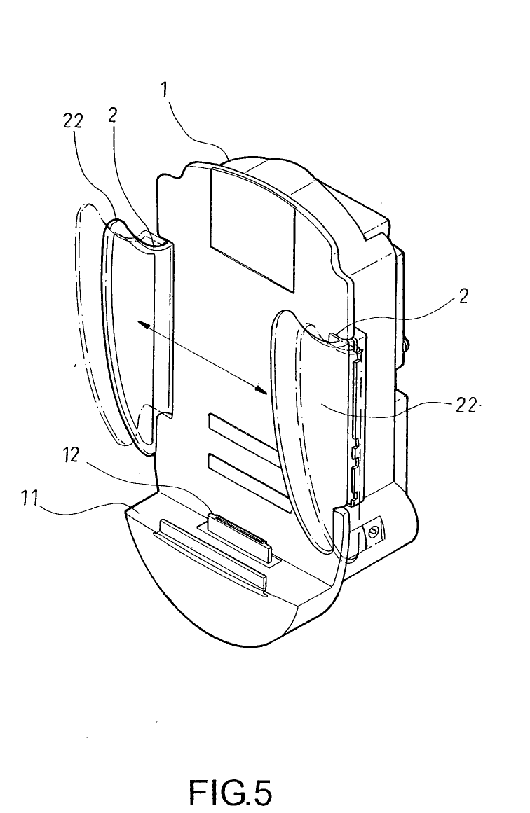

Referring to FIG. 5. After being fixed on a fixture, the docking cradle is ready to accommodate a mobile phone, a PDA, or a GPS on a space between fenders 22, with the socket 12 to connect to the antenna 3 to form a hand-free device.

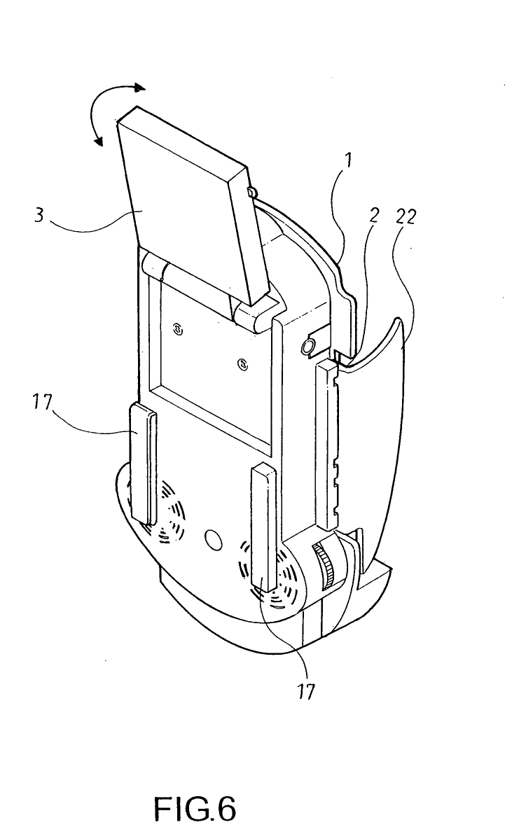

Referring to FIG. 6. The antenna 3 can be turned upward, downward, rightward, or leftward around the hinge complex 16 to obtain the best radio receiving quality for a mobile phone or a GPS.

It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A docking cradle on a vehicle comprising:
a main body having a cradle with a socket formed on the bottom thereof, wherein the socket can be changed for different applications such as a mobile phone, a PDA, or a GPS;
a pair of symmetric fixing plate assemblies with a pair of symmetric plates formed in the front and a hinge complex formed in the rear for connecting with an antenna rotating around thereof and with a dual rail formed on each side thereof;
plates, being joined through a spring to a fixing pole, having a fender formed on each side, two long holes hooking at positioning rods, and chains gearing with a chain wheel;
an electronic circuit board formed in the main body;
With the width-adjustable fender and the azimuth-adjustable antenna, portable electronic devices thereby being able to be fitted into the docking cradle and connected to the socket as a hand-free device with the best radio receiving quality.
